(19) United States
(12) Patent Application Publication
(10) Pub. No.: US 2025/0346221 A1
(43) Pub. Date: Nov. 13, 2025

(54) PARKING ASSISTANCE DEVICE

(71) Applicant: TOYOTA JIDOSHA KABUSHIKI KAISHA, Toyota-shi (JP)

(72) Inventors: Asuka SHIMIZU, Nagoya-shi (JP); Daisuke SUZUKI, Okazaki-shi (JP)

(73) Assignee: TOYOTA JIDOSHA KABUSHIKI KAISHA, Toyota-shi (JP)

(21) Appl. No.: 19/203,717

(22) Filed: May 9, 2025

(30) Foreign Application Priority Data
May 13, 2024 (JP) 2024-077879

(51) Int. Cl. B60W 30/06; B60W 50/14

(52) U.S. Cl. CPC B60W 30/06; B60W 50/14; B60W 2050/143; B60W 2050/146; B60W 2420/403; B60W 2420/408; B60W 2420/54; B60W 2540/12; B60W 2556/40

(57) ABSTRACT

The processor of the parking assistance device is configured to, in a predetermined scene where the processor controls the own vehicle to travel toward the inside of the parking spot and reach a predetermined point, and subsequently controls the own vehicle to travel from the predetermined point toward the outside of the parking spot, when a proportion of a portion of the own vehicle that has entered the parking spot relative to the entire own vehicle exceeds a threshold at the predetermined point, control the own vehicle to stop at the predetermined point; and when the processor detects that a driver of the own vehicle has executed a predetermined operation while the own vehicle is stopped at the predetermined point, control the own vehicle to travel toward the outside of the parking spot.

### BACKGROUND

The present invention relates to a parking assistance device that supports a driving operation for parking an own vehicle in a parking spot.

### DESCRIPTION OF THE RELATED ART

A parking assistance device that supports a driving operation for parking an own vehicle in a parking spot has been proposed (for example, see Patent Document 1). This type of parking assistance device (hereinafter referred to as “conventional device”) includes a vehicle-mounted sensor, such as a camera or radar, for acquiring information regarding an object located around the own vehicle, and a processor that controls a drive device, braking device, and steering device of the own vehicle (hereinafter collectively referred to as “drive devices, etc.”). The processor identifies the parking spot based on the information acquired from the vehicle-mounted sensor and obtains (calculates) a target route for allowing the own vehicle to enter the parking spot. The processor controls the drive devices, etc., so that the own vehicle travels along the target route. During the process in which the own vehicle travels along the route, the position and orientation of the own vehicle with respect to the parking spot change. Accordingly, during this process, the output of the vehicle-mounted sensor (information regarding the parking spot and surrounding objects) is sequentially updated. The processor sequentially acquires information from the vehicle-mounted sensor. Based on the information acquired from the start of processing (control of the drive devices, etc.) for parking the own vehicle in the parking spot up to the present time, the processor sequentially updates the target route. The processor stops the own vehicle and activates the parking brake when it detects that the own vehicle is entirely within the parking spot and a predetermined margin is provided between the inner peripheral edge of the parking spot and the outer peripheral surface of the own vehicle. Subsequently, the processor shifts the shift position to the parking position and stops the engine.
Patent Document 1: Japanese Unexamined Patent Application Publication No. 2021-160476

### Summary

In the process in which the processor of the conventional device parks the own vehicle in the parking spot, there may be a situation where the driving direction of the own vehicle is switched from a direction toward the inside of the parking spot to a direction toward the outside of the parking spot in order to correct (optimize) the lateral position of the own vehicle relative to the parking spot (for example, a situation where the vehicle switches from reversing to forwarding). Here, a pedestrian or another vehicle near the parking spot may anticipate that, when the own vehicle is traveling toward the inside of the parking spot and most of the own vehicle is already within the parking spot, the own vehicle will continue moving toward the inside of the parking spot to complete parking. That is, such a pedestrian or another vehicle may predict that the likelihood of the own vehicle reversing direction and traveling toward the outside of the parking spot is low. In this case, there is a risk that the pedestrian may enter the front area of the own vehicle (the area through which the own vehicle will pass when traveling toward the outside of the parking spot).

One of the objectives of the present invention is to provide a parking assistance device that can enhance the safety of pedestrians around the own vehicle.

To achieve the above objective, a parking assistance device (1) of the present invention comprises:
a vehicle-mounted sensor (20) configured to acquire information regarding an object located around an own vehicle (V0); and
a processor (10) configured to control the own vehicle (30, 40, 50) so that the own vehicle travels from outside a parking spot (PS) toward the parking spot and is parked within the parking spot based on the information acquired from the vehicle-mounted sensor.

The processor is configured to, in a predetermined scene where the processor controls the own vehicle to travel toward the inside of the parking spot and reach a predetermined point (P), and subsequently controls the own vehicle to travel from the predetermined point toward the outside of the parking spot,
when a proportion of a portion of the own vehicle that has entered the parking spot relative to the entire own vehicle exceeds a threshold at the predetermined point,
control the own vehicle to stop at the predetermined point; and
when the processor detects that a driver of the own vehicle has executed a predetermined operation while the own vehicle is stopped at the predetermined point,
control the own vehicle to travel toward the outside of the parking spot.

The processor of the parking assistance device according to the present invention stops the own vehicle temporarily at the predetermined point when the own vehicle is to travel toward the outside of the parking spot from a state where most of the own vehicle has entered the parking spot at the predetermined point. In this state, the driver can check the safety of the surroundings. When the driver confirms that the surroundings are safe, the driver can execute the predetermined operation to allow the own vehicle to start moving toward the outside of the parking spot (resume the support by the parking assistance device, such as automatic control of the drive devices, etc.). As a result, the safety of pedestrians around the own vehicle is enhanced.

In a parking assistance device according to one embodiment of the present invention,
the processor is configured to control a notification device (60) of the own vehicle so that information prompting the driver of the own vehicle to check the safety around the own vehicle is provided while the own vehicle is stopped at the predetermined point.

Accordingly, when the own vehicle reaches the predetermined point, information (e.g., images and/or voice guidance) prompting the driver to check the surroundings for safety is provided. Therefore, the driver can promptly start confirming the safety around the own vehicle.

In another embodiment of the parking assistance device according to the present invention,
the processor is configured to determine that the predetermined operation has been executed when it detects that a brake pedal has been depressed.

When the processor controls the own vehicle (braking device) so that the own vehicle stops at the predetermined point, the brake pedal is not in use. That is, in this state, the brake pedal is released, meaning that the depression depth of the brake pedal is “0.” In this state, when the depression depth of the brake pedal exceeds a threshold, the processor determines that the driver has completed checking the safety of the surroundings and is requesting to start the own vehicle.

Accordingly, compared to the case where a dedicated operation device for starting the own vehicle is provided, the number of components is reduced. As a result, component costs and manufacturing costs can be reduced.

In another embodiment of the parking assistance device according to the present invention,
the processor is configured to acquire a map (M) indicating a positional relationship between the own vehicle and the parking spot in a plan view based on the information acquired from the vehicle-mounted sensor,
acquire a first area (S0), which is the total area of the own vehicle in the map, and a second area (S1), which is the area of a portion of the own vehicle that has entered the parking spot in the map, at the predetermined point, and control the own vehicle to stop at the predetermined point when a ratio (S1/S0) of the second area to the first area exceeds a threshold (Sth).

Accordingly, the processor can relatively easily determine whether the current situation corresponds to a scene in which the own vehicle should be temporarily stopped at the predetermined point to prompt the driver to check the safety of the surroundings.

### BRIEF DESCRIPTION OF THE DRAWINGS

FIG. 1 is a block diagram of a parking assistance device according to an embodiment of the present invention.

FIG. 2 is a plan view (map) showing an example in which the own vehicle is parked in a parking spot through parking assistance processing.

FIG. 3 is a plan view showing a range in which a sensor can accurately detect objects.

FIG. 4 is a plan view (map) showing a first scene in which the own vehicle travels toward the outside of the parking spot from the predetermined point within the parking spot.

FIG. 5 is a plan view (map) showing a second scene in which the own vehicle travels toward the outside of the parking spot from the predetermined point within the parking spot.

FIG. 6 is a flowchart of a program executed by a CPU to realize the parking assistance function.

### DESCRIPTION OF THE EMBODIMENTS

### Summary

A parking assistance device 1 according to an embodiment of the present invention is applied to, for example, a vehicle V0 equipped with an autonomous driving function (hereinafter referred to as “own vehicle”). The parking assistance device 1 includes an automatic parking function that allows the own vehicle to enter and park within a specific parking spot PS from outside the parking spot PS. The parking assistance device 1 is configured to, when switching the traveling direction of the own vehicle from a first direction (toward the inside of the parking spot PS) to a second direction (toward the outside of the parking spot PS) after most of the own vehicle has entered the parking spot PS, temporarily stop the own vehicle at a switching point P. Then, if it is detected that the driver has executed a predetermined operation indicating confirmation of surrounding safety while the own vehicle is stopped at the point P, the parking assistance device 1 causes the own vehicle to start traveling in the second direction.

### (Specific Configuration)

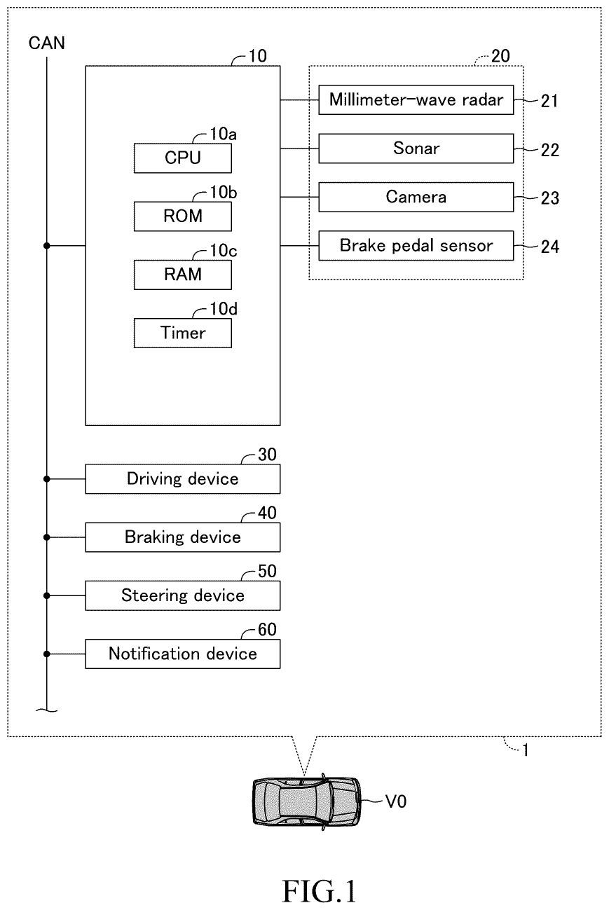

As shown in FIG. 1, the parking assistance device 1 includes a parking assistance ECU 10, a vehicle-mounted sensor 20, a drive device 30, a braking device 40, a steering device 50, and a notification device 60.

The parking assistance ECU 10 includes a microcomputer comprising a CPU 10a, ROM 10b, RAM 10c, a timer 10d, and other components. The parking assistance ECU 10 is connected to other ECUs provided in the own vehicle via a Controller Area Network (CAN).

The vehicle-mounted sensor 20 includes surrounding sensors for acquiring information regarding objects present around the own vehicle. Specifically, the vehicle-mounted sensor 20 includes a millimeter-wave radar 21, a sonar 22, and a camera 23 as surrounding sensors.

The millimeter-wave radar 21 includes a transmission/reception unit and a signal processing unit (not shown). The transmission/reception unit emits millimeter-wave electromagnetic waves (hereinafter referred to as “millimeter waves”) around the own vehicle and receives reflected millimeter waves (reflected waves) from three-dimensional objects located within the radiation range. The signal processing unit calculates the distance between the own vehicle and the three-dimensional object, the position (direction) of the three-dimensional object relative to the own vehicle, and the velocity of the three-dimensional object relative to the own vehicle based on factors such as the time from the transmission of the millimeter waves to the reception of the reflected waves, the phase difference between the transmitted and received millimeter waves, and the attenuation level of the reflected waves, and transmits the calculation results to the parking assistance ECU 10.

The sonar 22 intermittently emits ultrasonic waves into the surrounding area of the own vehicle and receives ultrasonic waves (reflected waves) that are reflected by three-dimensional objects. The sonar 22 calculates the distance between the own vehicle and the three-dimensional object, as well as the position (direction) of the three-dimensional object relative to the own vehicle, based on the time from the transmission of the ultrasonic waves to the reception of the reflected waves. The calculation results are then transmitted to the parking assistance ECU 10.

The camera 23 includes an imaging device and an image analysis device. The imaging device is a digital camera incorporating an imaging sensor, such as a CCD (Charge Coupled Device) or a CIS (CMOS Image Sensor). The imaging device is directed forward at the upper part of the front windshield glass. It captures images of the foreground of the own vehicle at a predetermined frame rate to acquire image data. The imaging device transmits the image data to the image analysis device. The image analysis device analyzes the acquired image data and extracts information about objects located in front of the own vehicle. For example, the image analysis device identifies (recognizes) the type of object in front of the own vehicle (such as another vehicle or a lane-marking line) and transmits the identification results to the parking assistance ECU 10.

In addition, the vehicle-mounted sensor 20 includes a brake pedal sensor 24 that detects the depression depth BD of the brake pedal.

The drive device 30 applies driving force to the drive wheels. The drive device 30 includes an engine ECU, an internal combustion engine, and a drive force transmission mechanism (such as a transmission) that transmits the driving force to the wheels. The engine ECU acquires information (target values) indicating the target driving force and target shift position from other ECUs (such as the parking assistance ECU 10). Based on this information, the engine ECU controls the throttle valve opening of the internal combustion engine and the actuators of the transmission to adjust the driving force applied to the drive wheels.

If the vehicle to which the parking assistance device 1 is applied is a hybrid electric vehicle (HEV), the engine ECU can control the driving force generated by either or both of the “internal combustion engine and electric motor” as vehicle drive sources. If the vehicle is a battery electric vehicle (BEV), an electric motor ECU, which controls the driving force generated by the “electric motor” as the vehicle drive source, may be used instead of the engine ECU.

The braking device 40 applies braking force to the wheels (brake discs). The braking device 40 includes a brake ECU and brake calipers. The brake calipers include actuators that press brake pads against the brake discs. The brake ECU acquires information (target values) indicating the target braking force from other ECUs and, based on this information, drives the actuators of the brake calipers to adjust the braking force applied to the wheels (brake discs).

The steering device 50 controls the steering angle of the steering wheels (left front wheel and right front wheel). The steering device 50 includes a steering ECU and a steering mechanism. The steering mechanism consists of a linkage system, including knuckle arms and tie rods. The steering device 50 also includes actuators that drive the steering mechanism to change the steering angle. The steering ECU acquires information (target values) indicating the target steering angle from other ECUs and, based on this information, drives the actuators to adjust the steering angle.

The notification device 60 includes an audio device and a display device. The audio device plays a predetermined sound (beep) in response to a command transmitted from the parking assistance ECU 10. The display device displays predetermined images (such as messages or icons) in response to a command transmitted from the parking assistance ECU 10.

### (Parking Assistance Function)

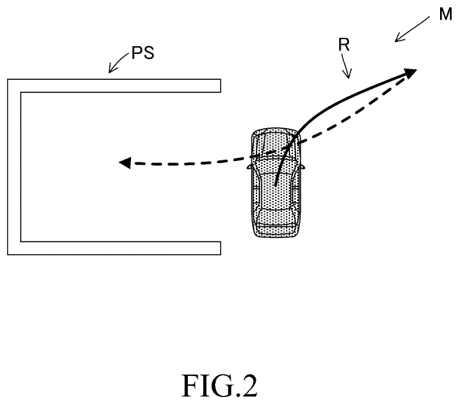

Next, the parking assistance function of the parking assistance device 1 will be described. The parking assistance ECU 10 starts a predetermined parking assistance process when it detects that a predetermined start operation (for example, switching a parking assistance switch from the off state to the on state) has been executed while the own vehicle is in a stopped state. Specifically, the parking assistance ECU 10 acquires various information from the millimeter-wave radar 21, the sonar 22, and the camera 23, and based on this information, acquires the positions of objects located around the own vehicle. Then, as shown in FIG. 2, the parking assistance ECU 10 generates (acquires) a map M (plan view) that indicates the positional relationship between the own vehicle and each object. If the parking assistance ECU 10 detects that a parking spot PS where the own vehicle can be parked is present near the own vehicle based on the acquired positions of the objects, it calculates the position and orientation of the own vehicle relative to the parking spot PS and reflects the calculation results in the map M. The driver can select the parking direction of the own vehicle in the parking spot PS (rear parking or forward parking) using an operation device (not shown). Additionally, if the parking assistance ECU 10 does not detect a parking spot PS where the own vehicle can be parked, it displays a predetermined image on the notification device 60 and plays a predetermined sound to prompt the driver to manually move the own vehicle near a parking spot.

When the parking assistance ECU 10 detects the parking spot PS, it sets (calculates) a target route R (a target trajectory of the own vehicle's center of gravity) based on the map M to allow the own vehicle to move into the parking spot PS while avoiding obstacles.

Next, the parking assistance ECU 10 sets a control signal pattern (time-series data of various target values supplied to the drive device 30, the braking device 40, and the steering device 50) to move the own vehicle along the target route R.

Then, the parking assistance ECU 10 controls the drive device and other components according to the control signal pattern to move the own vehicle along the target route R.

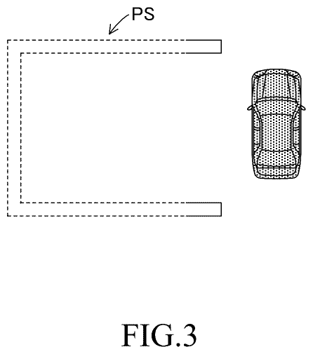

Meanwhile, the detection range (field of view) of the millimeter-wave radar 21, the sonar 22, and the camera 23 is relatively narrow. Therefore, as shown in FIG. 3, in the map M, the recognition accuracy of objects near the own vehicle (indicated by a solid-line area) is relatively high, whereas the recognition accuracy of objects farther away (indicated by a dashed-line area) is lower. During the process of moving the own vehicle according to the control signal pattern, the parking assistance ECU 10 sequentially acquires various information from the millimeter-wave radar 21, the sonar 22, and the camera 23 and updates the target route R based on this information.

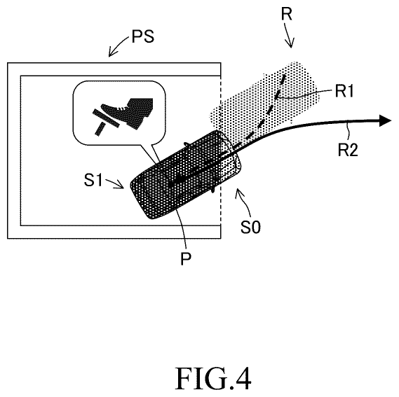

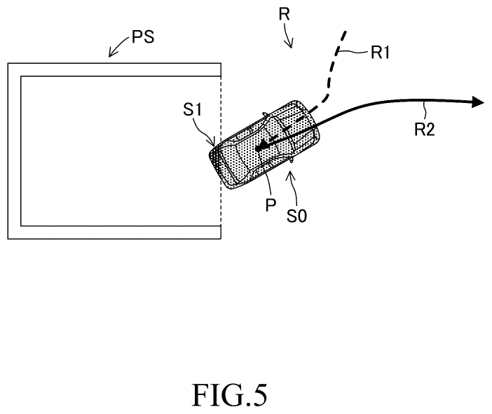

For example, as shown in FIGS. 4 and 5, in a scene where the own vehicle is being parked in the parking spot PS in a rearward parking manner, the parking assistance ECU 10 may move the own vehicle backward along route R1 to reach a predetermined point P near or within the parking spot PS and then reverse the traveling direction of the own vehicle from point P. That is, in these examples, the parking assistance ECU 10 moves the own vehicle forward along route R2 from point P. In other words, the parking assistance ECU 10 moves the own vehicle toward the inside of the parking spot PS along route R1 to reach point P and then moves the own vehicle toward the outside of the parking spot PS from point P.

As shown in FIG. 4, when most of the own vehicle's body is within the parking spot PS at point P (the point where the traveling direction of the own vehicle is switched), pedestrians near the parking spot PS may predict that the vehicle V0 will continue reversing and complete parking. In this case, if pedestrians assume that the vehicle V0 is unlikely to reverse its traveling direction and move toward the outside of the parking spot PS, there is a risk that these pedestrians may enter the front area of the own vehicle (route R2).

Therefore, as described below, when most of the own vehicle has entered the parking spot PS at point P, the parking assistance ECU 10 executes an alert process and a restart process.

### (Alert Process)

At point P, the parking assistance ECU 10 calculates the total area S0 (first area) of the own vehicle's body in the map M and the area S1 (second area) of the portion of the own vehicle's body that has entered the parking spot PS. When the ratio of S1 to S0 (the proportion of the own vehicle that has entered the parking spot PS) exceeds a threshold Sth (e.g., 80%), the parking assistance ECU 10 determines that most of the own vehicle has entered the parking spot. In this case, the parking assistance ECU 10 stops the own vehicle at point P. The parking assistance ECU 10 keeps the own vehicle stopped until the driver performs a predetermined operation (restart request operation) described later. Additionally, the parking assistance ECU 10 prompts the driver to be cautious of pedestrians around the own vehicle by displaying a predetermined image (such as a specific message or an image of the surroundings captured by the camera 23) on the notification device 60 and playing a predetermined sound (beep).

### (Restart Process)

When the driver confirms that the surroundings of the own vehicle are safe (i.e., no pedestrians are approaching the own vehicle) and requests to continue the parking assistance process (i.e., to start the own vehicle toward the outside of the parking spot PS), the driver temporarily depresses the brake pedal and then releases it within a short period. The parking assistance ECU 10 determines that the restart operation has been executed when the brake pedal depression depth BD exceeds a threshold BDth (e.g., 50% of the maximum depth or full stroke) and subsequently returns to “0” within a predetermined period (e.g., within 3 seconds). In this case, the parking assistance ECU 10 starts controlling the drive device and other components so that the own vehicle moves toward the outside of the parking spot PS along route R.

As shown in FIG. 5, when the own vehicle has not entered the parking spot PS significantly at point P (S1/S0≤Sth), the parking assistance ECU 10 immediately moves the own vehicle toward the outside of the parking spot PS, regardless of whether the restart operation has been performed.

The parking assistance ECU 10 terminates the parking assistance process when it detects that the own vehicle is completely within the parking spot PS and a predetermined margin is provided between the inner peripheral edge of the parking spot PS and the outer surface of the own vehicle. Specifically, the parking assistance ECU 10 controls the drive device and other components to stop the own vehicle and activates the parking brake. Then, the parking assistance ECU 10 shifts the shift position to the parking position and stops the drive device 30.

If a predetermined cancellation condition is met while the parking assistance process is being executed (while the own vehicle is being moved according to the control signal pattern), the parking assistance ECU 10 cancels the parking assistance process.

For example, the parking assistance ECU 10 determines that the cancellation condition is met when it newly detects an obstacle and is unable to set a target route R for parking the own vehicle in the parking spot PS while avoiding the obstacle. Additionally, the parking assistance ECU 10 determines that the cancellation condition is met when it measures the duration Δt in which the brake pedal depression depth BD exceeds the threshold BDth and finds that the measured result exceeds a threshold Δtth. In this case, the parking assistance ECU 10 displays an image indicating that the parking assistance process cannot be continued on the notification device 60 and plays a predetermined sound.

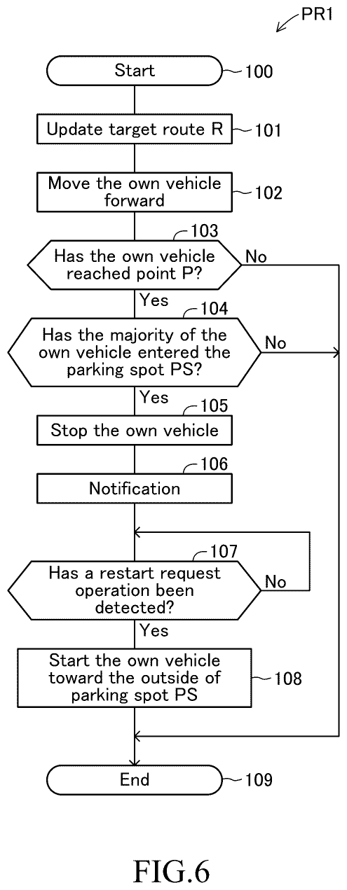

Next, referring to FIG. 6, the program PR1 executed by the CPU 10a (hereinafter referred to as “CPU”) of the parking assistance ECU 10 to realize the above-described parking assistance function will be described. The CPU executes the program PR1 at a predetermined cycle when a predetermined switch (parking assistance switch) is in the ON state.

### (Program PR1)

The CPU starts executing the program PR1 from step 100 and proceeds to step 101.

In step 101, the CPU sets (updates) the target route R based on the information acquired from the millimeter-wave radar 21, the sonar 22, and the camera 23. Then, the CPU proceeds to step 102.

In step 102, the CPU controls the drive device and other components so that the own vehicle travels a predetermined minute distance Δd along the target route R. Then, the CPU proceeds to step 103.

In step 103, the CPU determines whether the own vehicle has reached point P (the point where the traveling direction of the own vehicle is switched from the first direction toward the inside of the parking spot PS to the second direction toward the outside of the parking spot PS). If the CPU determines that the own vehicle has reached point P (103: Yes), it proceeds to step 104. On the other hand, if the CPU determines that the own vehicle has not reached point P (103: No), it proceeds to step 109 and terminates the execution of program PR1 in step 109.

In step 104, the CPU determines whether most of the own vehicle has entered the parking spot PS (S1/S0>Sth) based on the information acquired from the millimeter-wave radar 21, the sonar 22, and the camera 23. If the CPU determines that most of the own vehicle has entered the parking spot PS (104: Yes), it proceeds to step 105. On the other hand, if the CPU determines that most of the own vehicle has not entered the parking spot PS (104: No), it proceeds to step 109 and terminates the execution of program PR1 in step 109.

In step 105, the CPU stops the own vehicle. Then, the CPU proceeds to step 106.

In step 106, the CPU controls the notification device 60 to provide predetermined information (images and sounds) prompting the driver to check the safety of the surroundings. Then, the CPU proceeds to step 107.

In step 107, the CPU determines whether the driver has executed the restart operation (brake pedal depression and release operation). If the CPU determines that the driver has executed the restart operation (107: Yes), it proceeds to step 108. On the other hand, if the CPU determines that the driver has not executed the restart operation (107: No), it returns to step 107.

In step 108, the CPU starts the own vehicle toward the outside of the parking spot PS. Then, the CPU proceeds to step 109 and terminates the execution of program PR1 in step 109.

The CPU forcibly terminates the execution of program PR1 when an end condition is met during the execution of program PR1. For example, if the CPU is unable to set (update) the target route R in step 101, it determines that the end condition has been met and forcibly terminates the execution of program PR1. When the end condition is met, the CPU controls the notification device 60 to provide information to the driver indicating that the parking assistance process cannot be executed and switches the parking assistance switch to the OFF state.

### (Effects)

The parking assistance ECU 10 of the parking assistance device 1 temporarily stops the own vehicle at point P when the own vehicle is about to travel toward the outside of the parking spot PS from a state where most of the own vehicle has entered the parking spot PS. In this state, the driver can check the safety of the surroundings. When the driver has confirmed that the surroundings are safe, the driver can execute a predetermined brake pedal operation (restart operation) to allow the own vehicle to start moving toward the outside of the parking spot PS (resume assistance by the parking assistance device). As a result, the safety of pedestrians around the own vehicle is enhanced.

It should be noted that the present invention is not limited to the above-described embodiment and may be implemented in various modified forms within the scope of the present invention.

### Modification 1

FIGS. 3 to 5 illustrate an example in which the present invention is applied to a scene where the own vehicle is parked in the parking spot PS in a rearward parking manner. However, the present invention may also be applied to a scene where the own vehicle is parked in the parking spot PS in a forward parking manner. Specifically, the parking assistance ECU 10 moves the own vehicle forward to reach point P and stops the own vehicle at point P when most of the own vehicle has entered the parking spot PS. Then, if the parking assistance ECU 10 detects that the driver has executed the restart operation in this state, it moves the own vehicle backward toward the outside of the parking spot PS. The present invention may also be applied to a scene where the own vehicle is parked in the parking spot PS in a parallel parking manner.

### Modification 2

In the above embodiment, the parking assistance ECU 10 is configured to move the own vehicle toward the outside of the parking spot PS when it detects that the brake pedal has been depressed while the own vehicle is stopped at point P and subsequently released within a predetermined period. Instead of this, the parking assistance ECU 10 may be configured to move the own vehicle toward the outside of the parking spot PS when it detects that a predetermined operation device other than the brake pedal has been operated in a predetermined manner (for example, when a predetermined push-button switch provided on the steering wheel has been pressed) while the own vehicle is stopped at point P.

What is claimed is:

1. A parking assistance device comprising:
a vehicle-mounted sensor configured to acquire information regarding an object located around an own vehicle; and
a processor configured to control the own vehicle to travel from outside a parking spot toward the parking spot and park within the parking spot based on the information acquired from the vehicle-mounted sensor;
wherein the processor is configured to:
in a predetermined scene where the processor controls the own vehicle to travel toward the inside of the parking spot and reach a predetermined point, and subsequently controls the own vehicle to travel from the predetermined point toward the outside of the parking spot,
when a proportion of a portion of the own vehicle that has entered the parking spot relative to the entire own vehicle exceeds a threshold at the predetermined point,
control the own vehicle to stop at the predetermined point; and
when the processor detects that a driver of the own vehicle has executed a predetermined operation while the own vehicle is stopped at the predetermined point,
control the own vehicle to travel toward the outside of the parking spot.

2. The parking assistance device according to claim 1, wherein the processor is configured to control a notification device of the own vehicle so that information prompting the driver of the own vehicle to check the safety around the own vehicle is provided while the own vehicle is stopped at the predetermined point.

3. The parking assistance device according to claim 1, wherein the processor is configured to determine that the predetermined operation has been executed when it detects that a brake pedal has been depressed.

4. The parking assistance device according to claim 1, wherein the processor is configured to:
acquire a map indicating a positional relationship between the own vehicle and the parking spot in a plan view based on the information acquired from the vehicle-mounted sensor;
at the predetermined point, acquire a first area, which is the total area of the own vehicle in the map, and a second area, which is the area of a portion of the own vehicle that has entered the parking spot in the map; and
control the own vehicle to stop at the predetermined point when a ratio of the second area to the first area exceeds a threshold.
